(19) United States
(12) Patent Application Publication
(10) Pub. No.: US 2014/0045637 A1
(43) Pub. Date: Feb. 13, 2014

(54) DRIVETRAIN PROVIDED WITH A CVT

(71) Applicants: Jean-Francois Dionne, Saint-Hubert (CA); Jean-Robert Desmeules, Trois-Rivieres (CA); Francois Messier, Varennes (CA)

(72) Inventors: Jean-Francois Dionne, Saint-Hubert (CA); Jean-Robert Desmeules, Trois-Rivieres (CA); Francois Messier, Varennes (CA)

(73) Assignee: TRANSMISSION CVTCORP INC., Saint-Julie (CA)

(21) Appl. No.: 14/114,195

(22) PCT Filed: Apr. 26, 2012
(86) PCT No.: PCT/CA2012/000407

§ 371 Date: Oct. 25, 2013

Related U.S. Application Data
(60) Provisional application No. 61/480,395, filed on Apr. 29, 2011.

(51) Int. Cl. F16H 37/02

(52) U.S. Cl. CPC F16H 37/022
USPC 475/214; 475/219

(57) ABSTRACT

A compact drivetrain provided with a CVT that can be used in CVT low and high configurations and in a reverse configuration is described herein. In addition to the CVT, the drivetrain includes first and second planetary gear trains compactly mounted in series so as to selectively cooperate with the CVT and a configuration selection system coupled to both first and second planetary gear trains and to the output disk of the CVT for selectively associating the output shaft of the drivetrain to the outputs of the first and second planetary gear trains or to the output disk of the CVT for allowing the three modes of operation.

### FIELD

The present disclosure generally relates to vehicle drivetrains. More specifically, the present disclosure is concerned with a drivetrain provided with a Continuously Variable Transmission (CVT).

### BACKGROUND

CVTs are well known transmission mechanisms that can change trough an infinite number of gear ratios between upper and lower limits. Toroidal CVTs, which are also well known, include a disk and roller arrangement that transmits power between the disks, wherein one disk is the input and the other disk is the output. Such a transmission is used when transmission ratios have to be finely adjusted.

However, the ratio range required on a vehicle is often such that the size required for a CVT to cover the entire ratio range would be so large that it would be impractical to position it in some vehicle.

### SUMMARY

An object of illustrated embodiments is generally to provide an improved drivetrain including a CVT.

In accordance with an illustrative embodiment, there is provided a drivetrain for connection to the output of a prime mover and to the input of a final drive therebetween; the drivetrain comprising:
a CVT (Continuous Variable Transmission) including an input coupled to the output of the prime mover and an output; the CVT being so configured as to provide, between the input and output thereof, a primary continuous range of gear ratios;
a first planetary gear train having an input coupled to the output of the CVT and an output for coupling to the final drive; the first planetary gear train being so configured as to selectively provide, in cooperation with the CVT, a first secondary continuous gear ratio between the output of the prime mover and the input of the final drive;
a second planetary gear train having an input coupled to the output of the CVT and an output, coupled to the output of the first planetary gear train, for coupling to the final drive; the second planetary gear train being so configured as to selectively provide, in cooperation with the CVT, a second secondary continuous gear ratio between the output of the prime mover and the input of the final drive; and
a configuration selection system having a first input coupled to the output of the CVT, a second input coupled to both outputs of the first and second planetary gear sets and an output coupled to the input of the final drive; the configuration selection system being movable between a first configuration wherein the CVT is directly coupled to the input of the final drive, a second configuration wherein the CVT and the first planetary gear train are both cooperatively coupled to the input of the final drive, and a third configuration wherein the CVT and the second planetary gear train are both cooperatively coupled to the input of the final drive.

### BRIEF DESCRIPTION OF THE DRAWINGS

In the appended drawings:

FIG. 1 is a schematic bloc diagram of a drivetrain including a CVT according to a first illustrative embodiment;

FIG. 2 is a schematic bloc diagram of the drivetrain of FIG. 1 shown in a CVT low configuration;

FIG. 3 is a schematic bloc diagram of the drivetrain of FIG. 1 shown at the maximal speed of the CVT low configuration;

FIG. 4 is a schematic bloc diagram of the drivetrain of FIG. 1 shown in a CVT high configuration;

FIG. 5 is a schematic bloc diagram of the drivetrain of FIG. 1 shown at the maximal speed of the CVT high configuration;

FIG. 6 is a schematic bloc diagram of the drivetrain of FIG. 1 shown in a reverse configuration; and

FIG. 7 is a schematic bloc diagram of the drivetrain of FIG. 1 shown at the maximal speed of the reverse configuration.

### DETAILED DESCRIPTION

The use of the word “a” or “an” when used in conjunction with the term “comprising” in the claims and/or the specification may mean “one”, but it is also consistent with the meaning of “one or more”, “at least one”, and “one or more than one”. Similarly, the word “another” may mean at least a second or more.

As used in this specification and claim(s), the words “comprising” (and any form of comprising, such as “comprise” and “comprises”), “having” (and any form of having, such as “have” and “has”), “including” (and any form of including, such as “include” and “includes”) or “containing” (and any form of containing, such as “contain” and “contains”), are inclusive or open-ended and do not exclude additional, unrecited elements or process steps.

it is to be noted that the expression “prime mover” is to be construed herein and in the appended claims as an internal combustion engine a turbine engine, or any other mechanical power production element or assembly.

It is to be noted that the expression “overdrive” when used herein in the context of a CVT, is to be construed herein and in the appended claims as a condition where the CVT ratio is such that the CVT output speed is higher than the CVT input speed.

It is to be noted that the expression “underdrive” when used herein in the context of a CVT, is to be construed herein and in the appended claims as a condition where the CVT ratio is such that the CVT output speed is lower than the CVT input speed.

It is to be noted that the term “drivetrain”, used herein and in the appended claims, is to be construed as the intervening mechanism by which power is transmitted from a prime mover to a final drive as well as this mechanism plus the prime mover.

It will also be noted that the expressions “fixed disk”, when used herein and in the appended claims in the context of clutch technology, may be viewed as any element or group of elements constituting a clutch driving member. Similarly, the expressions “movable disk”, when used herein and in the appended claims in the context of clutch technology, may be viewed as any element or group of elements constituting a clutch driven member.

The expression “power downstream” and “downstream” should both be construed, herein and in the appended claims, as meaning that an element is positioned further away from a power source, such as a prime mover, relatively to another element. Similarly, the expressions “power upstream” and “upstream” should be construed as meaning that an element is positioned nearer a power source, relatively to another element.

The expression “connected” should be construed herein and in the appended claims broadly so as to include any cooperative or passive association between mechanical parts or components. For example, such parts may be assembled together by direct coupling, or indirectly coupled using further parts. The coupling can also be remote, using for example a magnetic field or else.

The expression “input”, without reference to a specific component such as a shaft, should be construed herein and in the appended claims, as including any movable part of an object, an assembly, a system or a mechanism that is used to receive a mechanical work from same or from another assembly, system or mechanism. Similarly, the expression “output” should be construed as including a similar part that is used to transfer a mechanical work.

Other objects, advantages and features will become more apparent upon reading of the following non-restrictive description of illustrative embodiments thereof, given by way of example only with reference to the accompanying drawings.

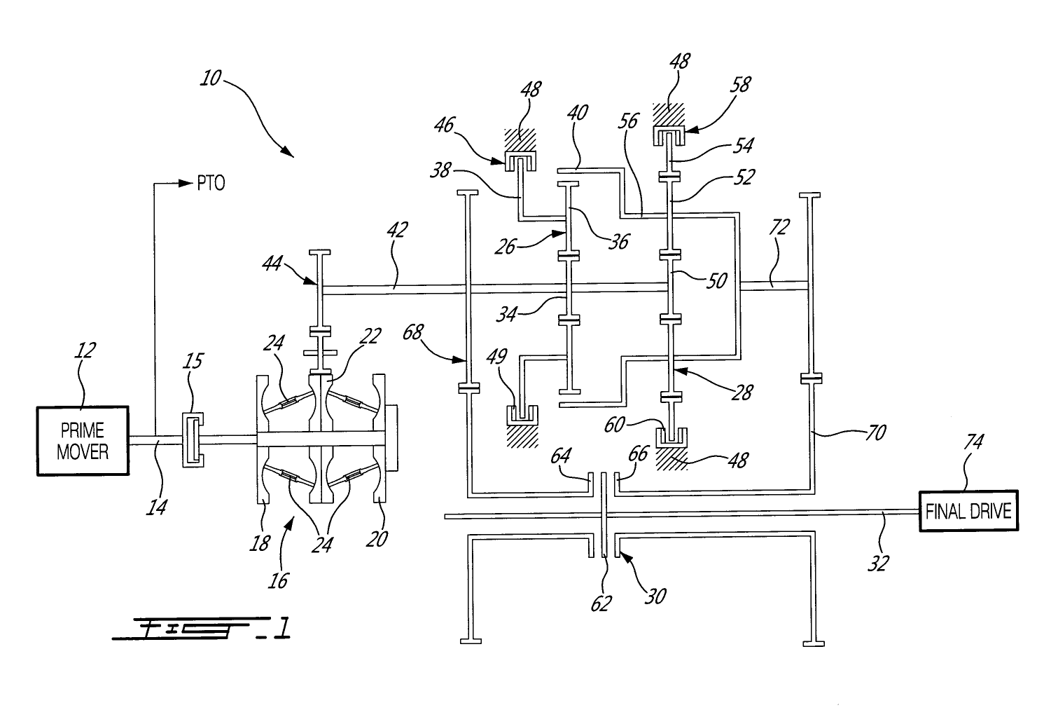

Turning now to FIG. 1 of the appended drawings, a drivetrain 10 according to a first illustrative embodiment will be described.

The drivetrain 10 includes a prime mover 12 provided with an output shaft 14 and a dual-cavity toroidal CVT 16 having two interconnected input disks 18 and 20 defining the input of the CVT 16 and connected to the prime mover 12 via a first clutch 15, an output disk 22 defining the output of the CVT 16 and six rollers 24 (only four shown) provided between the output disk 22 and the input disks 18 and 20. A PTO (power take-off) output is optionally connected to the output shaft 14 of the prime mover 12, upstream from the CVT 16. The CVT 16 is so configured as to provide a primary continuous primary range of gear ratios between its input and output.

The drivetrain 10 further includes a first planetary gear train 26, a second planetary gear train 28, and a clutch assembly 30 coupled to both first and second planetary gear trains 26 and 28 and to the output disk 22 of the CVT 16 for selectively associating an output shaft 32 of the drivetrain to the outputs of the first and second planetary gear trains 26 and 28 or to the output disk 22 of the CVT 16.

The first planetary gear train 26 includes a sun gear 34, planet gears 36, a planet carrier 38 and a ring gear 40.

The sun gear 34 is connected to a main shaft 42, which is connected to the output disk 22 of the CVT 16 via a gear set 44. The sun gear 34 acts as the input of the first planetary gear train 26 and the ring gear 40 acts as the output thereof.

A brake assembly 46 secured to the casing 48 is mounted to the planet carrier 38. The brake assembly 46 includes brake pads 49. Since such brake assemblies are believed to be well known, and for concision purposes, they will not be described herein in more detail. However, it is to be noted that the brake assembly 46 is not limited to the type including brake pads and can be for example of the magnetic type or else.

The second planetary gear train 28 includes a sun gear 50, planet gears 52, a ring gear 54 and a planet carrier 56. The planet carrier 56 is coupled to the ring gear 40 of the first planetary gear train 26. The planet carrier 56 also acts as the output of the second planetary gear train 28. While the planet carrier 56 and the ring gear 40 are shown as being integral, they could be connected using fasteners, or similar fastening means. Of course, other coupling arrangement can also be provided between the planet carrier 56 and ring gear 40.

The sun gear 50 acts as the input of the second planetary gear train 28 and is connected to the output disk of the CVT 16 via the main shaft 42 and gear set 44 similarly to the first planetary gear train 26.

Also, similarly to the planet carrier 38 of the first planetary gear train 26, the ring gear 54 of the secondary planetary gear train 28 is provided with a brake assembly 58 including brake pads 60. The brake assembly 58 is secured to the casing 48.

The clutch assembly 30 is a three-position clutch having a movable disk 62 fixedly mounted to the output shaft 32 of the drivetrain 10. The clutch assembly 30 further includes first and second fixed disks 64 and 66.

A first connection is created between the first fixed disk 64 and the CVT 16 through a gear set 68. A second connection is created, on the other side of the movable disk 62, between the second fixed disk 66 and the planet carrier 56 through another gear set 70 and a shaft 72.

It is to be understood that the fixed and moveable disks schematically represent the many disks that insure clutching in conventional electro-hydraulically actuated wet clutches. Of course, other types of clutches, such as dog clutches or electromagnetic clutches can be used.

The output shaft 32 is typically connected to a final drive 74, for example the differential of a vehicle.

It will be appreciated by one skilled in the art that the drivetrain 10 is only shown schematically in FIG. 1. Indeed, many required elements such as bearings, actuators and controller are not shown herein for clarity purpose.

The CVT 16, brake assemblies 46 and 58 and the clutch assembly 30 are coupled to a conventional main controller (not shown) that is responsible to selectively trigger these assemblies so as to allow one of the following three modes of operation and corresponding configurations of the drivetrain 10: CVT high, reverse and CVT low, also referred herein as the first, second and third configurations, respectively. As such, assemblies 46, 58 and 30 will be referred to herein as a configuration selection system.

Of course, one skilled in the art will understand that a main controller could be replaced by a manual control of the various elements.

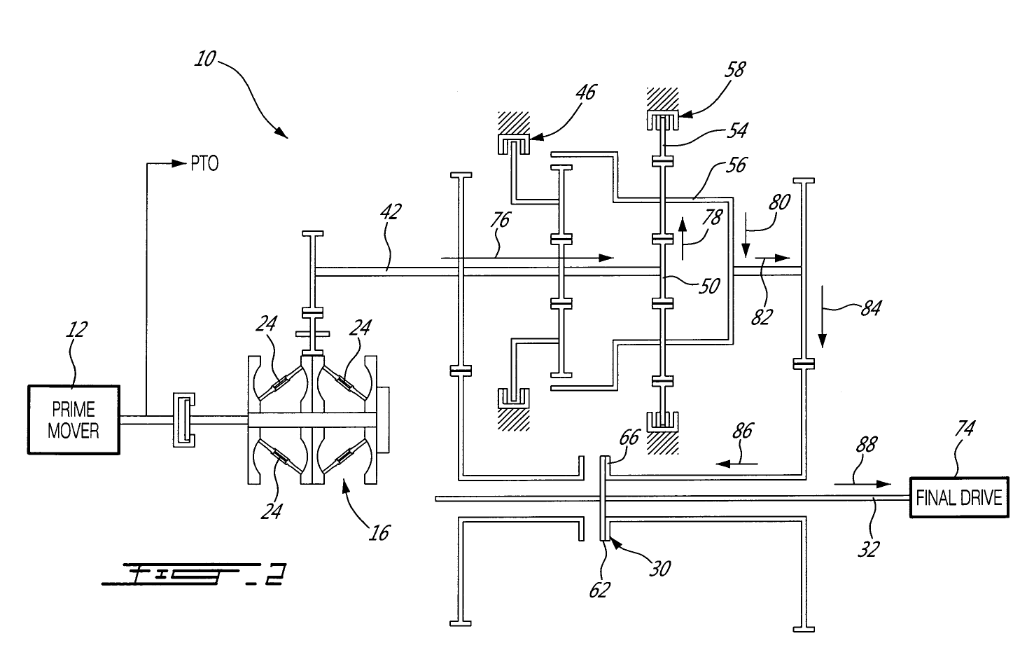

The various possible configurations of the drivetrain 10 and other characteristics and features thereof will become more apparent upon reading the following description of its operation with reference to FIGS. 2 to 7.

It is to be noted that in all mode of operations described hereinbelow, the first clutch 15 is engaged by the user when power is to be transferred from the prime mover 12 to the final drive 74.

FIG. 2 is a schematic bloc diagram of the drivetrain 10 shown in a CVT low configuration. Accordingly, the brake 58 is applied on the ring gear 54 so as to prevent its rotation and the movable disk 62 of the clutch assembly 30 engages the second fixed disk 66 thereby connecting the output shaft 32 to the planet carrier 56. The brake 46 is disengaged.

Power from the prime mover 12, via the CVT 16 is then transferred to the second sun gear 50 through the main shaft 42 (see arrow 76), to the planet carrier 56 via the planet gears 52 (see arrow 78) and to the final drive through the above-mentioned second connection (see arrows 80-88). It is to be noted that no power is transferred from the prime mover 12 to the final drive 74 via the first planetary gear train 26 since the brake 46 is not applied placing the first planetary gear train 26 in a freewheeling configuration.

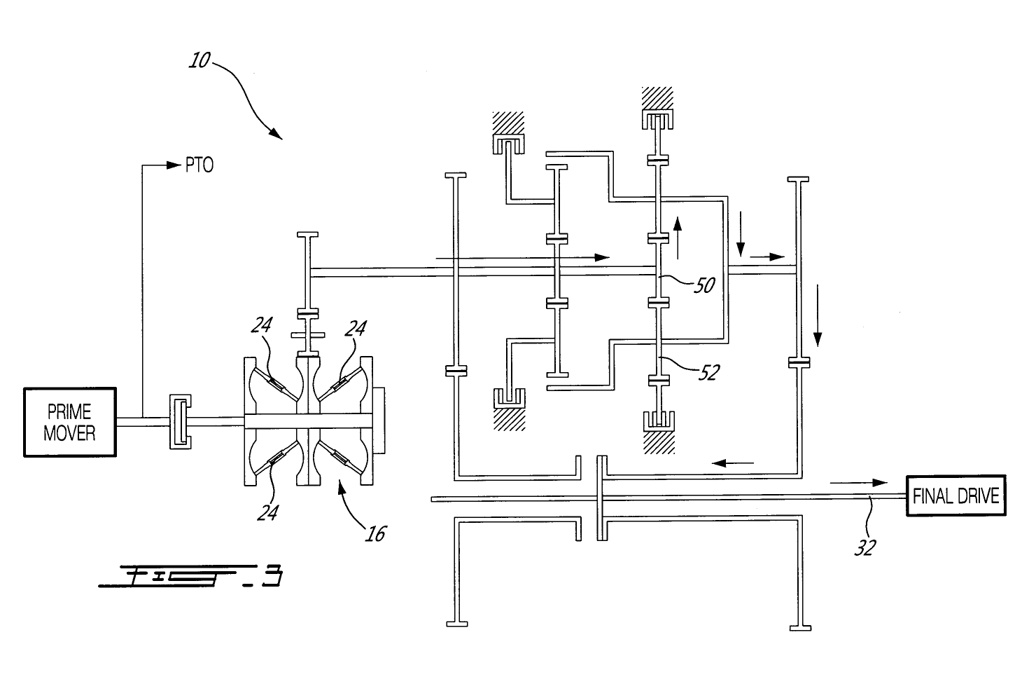

Assuming that the user desires to increase the speed of the vehicle, the position of the rollers 24 then gradually moves from the underdrive position shown in FIG. 2 to the overdrive position shown in FIG. 3. This directly causes the gradual increase of the speed of the sun and planet gears 50 and 52 and consequently of the shaft 32. FIG. 3 illustrates the configuration of the drivetrain 10 corresponding to the maximum speed of the CVT low configuration, i.e. when the CVT 16 is in its overdrive position. In other words, the second planetary gear train 28 is so configured as to selectively provide, in cooperation with the CVT 16, a second secondary continuous gear ratio between the output of the prime mover 12 and the input of the final drive 74.

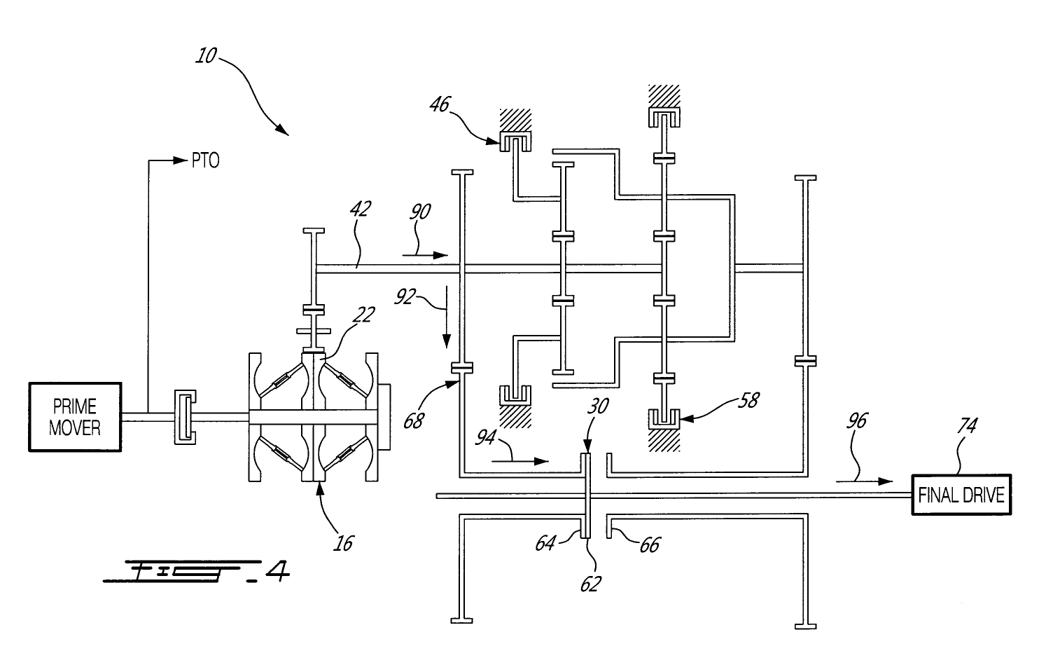

Turning now to FIG. 4, when such a maximum speed of the CVT low configuration is reached, the movable disk 62 of the clutch assembly 30 is moved from the second fixed 66 so as to engage the first fixed disk 64, enabling the above-mentioned first connection between the CVT 16 and the final drive 74, placing the drivetrain 10 in a CVT high configuration.

Power is then directly transferred from the CVT output disk 22 to the main shaft 42 (see arrow 90), through the gear set 68 (arrow 92) and then to the final drive 74 though the clutch assembly 30 (see arrows 94-96). It is to be noted that the brakes 46 and 58 should be engaged simultaneously.

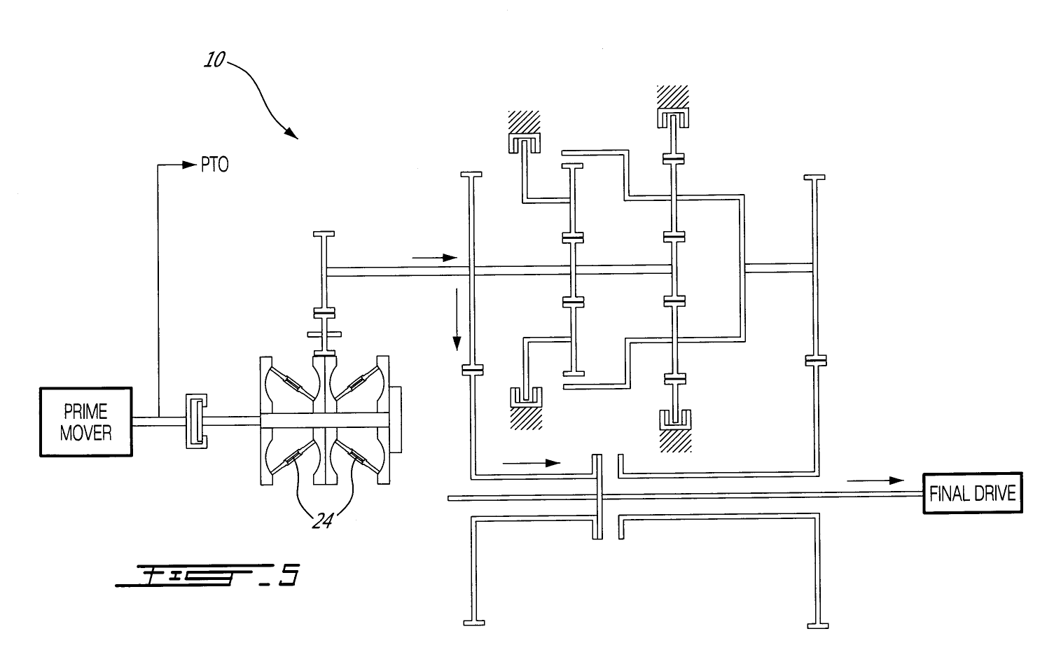

Again, assuming that the user desires to increase the speed of the vehicle, the position of the rollers 24 then gradually moves from the underdrive position shown in FIG. 4 to the overdrive position shown in FIG. 5. This corresponds to the maximum speed of the CVT high configuration.

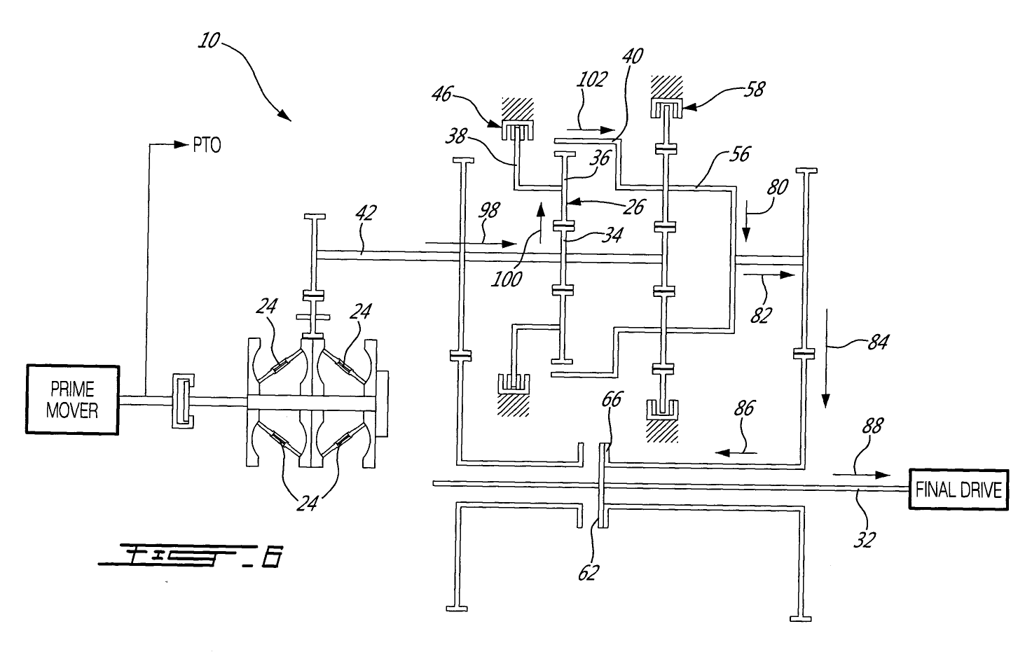

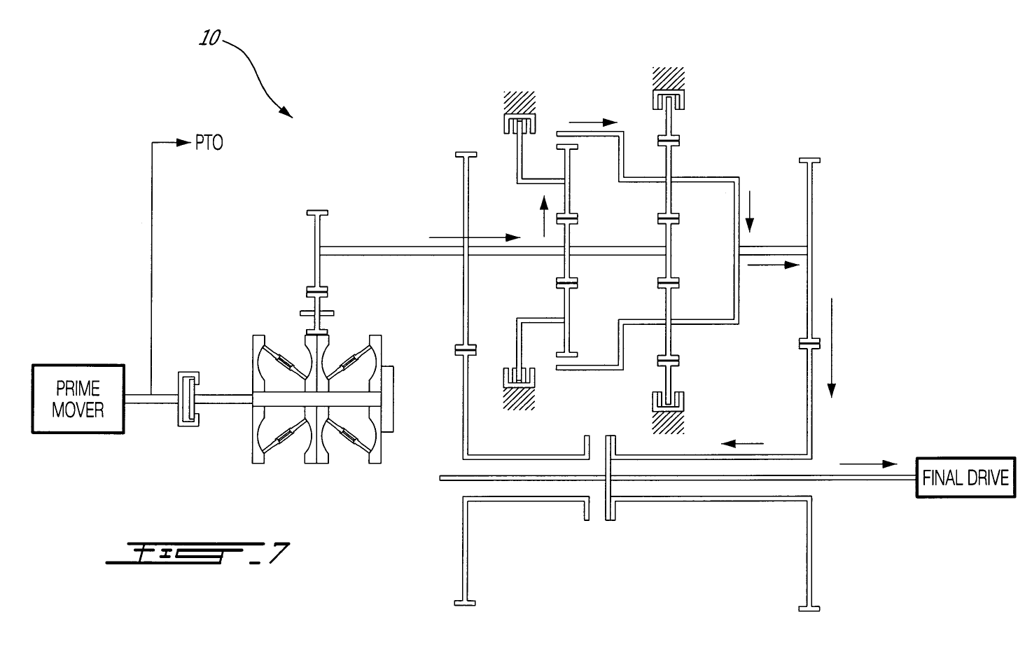

As will now be described with reference to FIGS. 6 and 7, the drivetrain 10 can be configured to achieve a reverse mode of operation.

The reverse mode of operation is provided when the movable disk 62 engages the second fixed disk 66 so as to enable the second connection and by engaging the brake 46 so as to prevent the planet carrier of the first planetary drivetrain 26 from rotating. The other brake 58 is disengaged.

It results from this configuration of the drivetrain 10 that power from the main shaft 42 (arrow 98) is transferred from the sun gear 34 of the first planetary drivetrain 26 to its ring gear 40 via the planet gears 36 (see arrows 100-102). That power is then transferred to the shaft 32 via the above-described second connection (see arrows 80-88).

Similarly to the other mode of operation of the drivetrain 10, assuming that the user desires to increase the speed of the vehicle in reverse mode, the position of the rollers 24 then gradually moves from the underdrive position shown in FIG. 6 to the overdrive position shown in FIG. 7. This corresponds to the maximum speed of the reverse configuration.

In other words, the first planetary gear train 26 is so configured as to selectively provide, in cooperation with the CVT 16, a first secondary continuous gear ratio between the output of the prime mover 12 and the input of the final drive 74.

A person skilled in the art will now appreciate that the gear sets 44 and 70 operates with the first and second planetary gear trains 26 and 28 so as to provide respective reverse and direct outputs relative to the output of the CVT 16. It is believed to be within the reach of the person skilled in the art to provide other arrangements of such components, with or without the addition of other gear sets so as to yield such direct and reverse outputs or the opposite.

Also, different and/or additional gear sets (not shown) and/or a different configuration of the first and second planetary gear trains 26 and 28 may be provided so as to achieve specific relative outputs in each of the CVT low, CVT high and reverse configurations.

The inputs and outputs of the CVT 16, and first and second planetary gear trains 26 and 28 have been described with reference to the provided gear ratios. It is believed to be within the reach of a person skilled in the art to use shaft speeds and torques to characterize and compare the different inputs and outputs of the components of the drivetrain 10. Correspondences between these parameters are believed to be well-known to the skilled technician and as such will not be described herein in more detail.

The prime mover 12 can be in the form of an engine, a turbine, an electric motor, etc.

One skilled in the art will understand that the entire range of speed of the drivetrain has been spanned without changing the speed of the prime mover 12.

One skilled in the art is believed to be in a position to design or to select appropriate parts of the drivetrain depending on the required maximal speed and torque required for a specific application.

One skilled in the art will understand that while a double cavity toroidal CVT has been illustrated herein, other CVT technologies could be used.

As will be apparent to one skilled in the art, the CVT could be so connected to the other elements that the disk 22 is an input disk and the disks 18 and 20 are output disks.

One skilled in the art will also understand that the various clutches described herein can use any clutch technology. For example, the clutches could be jaw, magnetic or hydraulic clutches. Of course, the various clutches do not need to be of the same type.

It is to be understood that the drivetrain provided with a CVT is not limited in its applications to the details of construction and parts illustrated in the accompanying drawings and described hereinabove. The drivetrain provided with a CVT is capable of other embodiments and of being practiced in various ways. It is also to be understood that the phraseology or terminology used herein is for the purpose of description and not limitation. Hence, although the drivetrain provided with a CVT has been described hereinabove by way of illustrative embodiments thereof, it can be modified, without departing from the spirit, scope and nature of the subject invention.

What is claimed is:

1. A drivetrain for connection to the output of a prime mover and to the input of a final drive therebetween; the drivetrain comprising:
a CVT (Continuous Variable Transmission) including an input coupled to the output of the prime mover and an output; the CVT being so configured as to provide, between the input and output thereof, a primary continuous range of gear ratios;
a first planetary gear train having an input coupled to the output of the CVT and an output for coupling to the final drive; the first planetary gear train being so configured as to selectively provide, in cooperation with the CVT, a first secondary continuous gear ratio between the output of the prime mover and the input of the final drive;
a second planetary gear train having an input coupled to the output of the CVT and an output, coupled to the output of the first planetary gear train, for coupling to the final drive; the second planetary gear train being so configured as to selectively provide, in cooperation with the CVT, a second secondary continuous gear ratio between the output of the prime mover and the input of the final drive; and
a configuration selection system having a first input coupled to the output of the CVT, a second input coupled to both outputs of the first and second planetary gear sets and an output coupled to the input of the final drive; the configuration selection system being movable between a first configuration wherein the CVT is coupled to the input of the final drive, a second configuration wherein the CVT and the first planetary gear train are both cooperatively coupled to the input of the final drive, and a third configuration wherein the CVT and the second planetary gear train are both cooperatively coupled to the input of the final drive.

2. A drivetrain as recited in claim 1, wherein the second configuration allowed by the configuration selection system results in the input of the final drive being rotated in an opposite direction than the input of the final drive resulting from the third configuration allowed by the configuration selection system.

3. A drivetrain as recited in claim 1, wherein the configuration selection system includes a clutch assembly for selectively coupling either one of the first and second inputs of the configuration selection system to the output thereof.

4. A drivetrain as recited in claim 3, wherein the configuration selection system further includes first and second brake assemblies coupled respectively to the first and second planetary gear trains for selectively enabling the cooperation thereof with the CVT and for allowing the respective first and second secondary continuous gear ratio between the prime mover and the final drive when the clutch assembly couples the second input of the configuration selection system to the output thereof.

5. A drivetrain as recited in claim 4, wherein the clutch assembly includes a three position clutch having a first fixed disk coupled to the output of the CVT, a second fixed disk coupled to the outputs of the first and secondary gear trains, and a movable disk for selective coupling to one of the first and second fixed disks.

6. A drivetrain as recited in claim 1, wherein the first planetary gear train includes a sun gear defining the input of the first planetary gear train coupled to the output of the CVT, a ring gear defining the output of the first planetary gear train for coupling to the final drive, planet gears mounted to both the sun gear and ring gear therebetween and a planet carrier.

7. A drivetrain as recited in claim 6, wherein the second planetary gear train includes a sun gear defining the input of the second planetary gear train coupled to the output of the CVT, a ring gear, planet gears mounted to both the sun gear and ring gear therebetween and a planet carrier; the planet carrier of the secondary gear train being coupled to the ring gear of the first planetary gear train.

8. A drivetrain as recited in claim 7, wherein the configuration selection system has first and second brake assemblies respectively mounted to the planet carrier of the first planetary gear train and to the ring gear of the second planetary gear train for selectively prevent rotational movements of these elements to thereby allow the respective first and second secondary continuous gear ratio between the prime mover and the final drive when the respective first and second planetary gear trains is coupled to the input of the final drive.

9. A drivetrain as recited in claim 7, wherein both sun gears of the first and second planetary gear trains are coupled to the output of the CVT via a main shaft and a gear set.

10. A drivetrain as recited in claim 1, wherein the second planetary gear train includes a sun gear, which is the input of the second planetary gear train coupled to the output of the CVT, a ring gear, planet gears mounted to both the sun gear and ring gear therebetween and a planet carrier defining the output of the second planetary gear train for coupling to the final drive.

11. A drivetrain as recited in claim 1, wherein the prime mover is selected from a group consisting of an engine, a turbine and an electric motor.

12. A drivetrain as recited in claim 1, wherein the CVT is of the toroidal type.

13. A drivetrain as recited in claim 12, wherein the input of the CVT is in the form of a disk and wherein the output of the CVT is in the form of a disk.

14. A drivetrain as recited in claim 12, wherein the toroidal CVT is of the double cavity type.
